(19) United States
(12) Patent Application Publication
(10) Pub. No.: US 2005/0010413 A1
(43) Pub. Date: Jan. 13, 2005

(54) Voice emulation and synthesis process

(76) Inventor: Jon Byron Norsworthy, Purcellville, VA (US)

Correspondence Address: Jon Byron Norsworthy, 424 Crossman Court, Purcellville, VA, 21032, US

(21) Appl. No.: 10/852,522

(22) Filed: May 24, 2004

Related U.S. Application Data
(60) Provisional application No. 60/472,923, filed on May 23, 2003.

(51) Int. Cl. G10L 15/00

(52) U.S. Cl. 704/254

(57) ABSTRACT

Our process utilizes the latest high resolution Digital Signal Processing to temporally analyze spoken human voices at the phoneme level. Our process creates digital signatures of every phoneme combination based upon temporal analysis rather than tonal spectral analysis. Our process then enables the identification and emulation of individual human voices through. Identification is enabled as phonemes being temporally analyzed are compared against those within an existing database. Emulation is enable through the creation and application of comparison algorithms representing the differences between the phonemes of the Emulated and those of the Emulator.

### CROSS REFERENCE TO RELATED APPLICATIONS

This application is based upon earlier Provisional Patent Application No. 60/472923 filed on May 23, 2003 by same sole inventor, Jon Byron Norsworthy

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROCESS LISTING COMPACT DISC APPENDIX

“Not Applicable”

### BACKGROUND OF THE INVENTION

Within the field of speech recognition, identification, and emulation, past and current efforts are based upon spectrally analyzed tonal inflections. Tonal analytical approaches have proven very difficult to apply when the human voice is speaking rather than singing. When the human voice is singing, it is tonal with repetition or cycles of the same measured tone. However, when the human voice is speaking it is not tonal but rather reflects a percussion effect, with a complex make up of phonemes all expressed differently based upon their placement before and after other phonemes as well as their placement within a sentence. Since there is no repetition or cycle within phonemes expressed with the speaking human voice, tonal or spectral approaches to recognition, identification, and emulation have proven very difficult. Our process falls within patent classification 704 “DATA PROCESSING: SPEECH SIGNAL PROCESSING, LINGUISTICS, LANGUAGE TRANSLATION, AND AUDIO COMPRESSION/DECOMPRESSION”. Our process touches upon several sub-classifications within 704, to include: 4; 211; 220; 236; 243; and 246.

### BRIEF SUMMARY OF THE INVENTION

Our process overcomes the difficulties experienced in tonal analysis (described above in Background of the Invention) by analyzing each phoneme in a specific segment of time through digital signal processing. Our process takes text converted from speech through other's existing speech to text processs and determines the all intended phonemes that were spoken. These phonemes are all analyzed within a precise segment of time through the science of Digital Signal Processing whereby a digital signature is created for each intended phoneme. Our process then catalogues these signatures into a database representing a certain individual's voice. Once all the phonemes are catalogued, voice identification and emulation are enabled. Identification is enabled by comparing future analyzed phonemes against an existing database. Emulation is enabled by creating comparison algorithms between the Emulator's phonemes and the Emulated's phonemes. Once the comparison algorithms are created they can then be applied to the Emulator's voice so that what is heard in output is the Emulated's voice.

### BRIEF DESCRIPTION OF THE SEVERAL VIEWS OF THE DRAWING

“Not Applicable”

### DETAILED DESCRIPTION OF THE INVENTION

Our process compiles voice signatures comprised of catalogued temporally analyzed phonemes (as opposed to the current art which is based on spectrally analyzed tonal inflections) spoken by that individual. These phonemes are gathered, analyzed, and catalogued in the following manner. As digital voice recordings are received, COTS voice to text converts the spoken voice file into a separate text file. Our process analyzes the written text to determine the intended phonemes that were spoken. Our process then, utilizing high-resolution digital signal processing, conducts time-based analysis of all of the phonemes spoken in the original voice file to include the variants of how the phoneme pronunciation changes in reference to its placement before and after other phonemes. Our process continues to catalogue all the variants of that individual's spoken phonemes, until a voice signature can be established (when all of the available recognizable phoneme variants have been catalogued).

Our process identifies voices that have been previously processed utilizing the above methodology. Our process looks for phoneme matches as new recordings are processed. As the process compiles voice signatures, and each phoneme variant is analyzed, these variants are compared against all previously processed phoneme signatures to find a match. When phoneme matches are identified then the process compares further processed phonemes to determine if there are further matches. Once a very high percentage (TBD) of phonemes match, it can be assumed that the recordings were made by the same individual.

Our process enables one individual to emulate the voice of another individual. Our process first creates a voice signature of the person to be emulated (Emulated) utilizing the methodology above. Our process then creates a voice signature of the person (Emulator) intending to emulate the Emulated's voice utilizing the methodology above. Our process then creates comparison algorithms between the various phoneme combinations of the Emulator and those of the Emulated. This process can be expedited by the Emulator speaking the same messages, previously spoken by the Emulated. Our process then breaks down the Emulator's message to the phoneme level and applies each respective comparison algorithm. Once all the comparison algorithms are applied to all of the phonemes, the message is released over the desired medium in the voice of the Emulated. If this message were to be analyzed for voice identification as outlined in number 2 above, the process would reflect the voice as belonging to the Emulated and not the Emulator.

1. Our program compiles voice signatures comprised of catalogued temporally analyzed phonemes (as opposed to the current art which is based on spectrally analyzed tonal inflections) spoken by that individual. These phonemes are gathered, analyzed, and catalogued in the following manner.
a. As digital voice recordings are received, COTS voice to text converts the spoken voice file into a separate text file.
b. Our program analyzes the written text to determine the intended phonemes that were spoken.
c. Our program then, utilizing high-resolution digital signal processing, conducts time-based analysis of all of the phonemes spoken in the original voice file to include the variants of how the phoneme pronunciation changes in reference to its placement before and after other phonemes.
d. Our program continues to catalogue all the variants of that individual's spoken phonemes, until a voice signature can be established (when all of the available recognizable phoneme variants have been catalogued).

2. Our program identifies voices that have been previously processed utilizing the above methodology.
a. Our program looks for phoneme matches as new recordings are processed. As the process compiles voice signatures, and each phoneme variant is analyzed, these variants are compared against all previously processed phoneme signatures to find a match.
b. When phoneme matches are identified then the program compares further processed phonemes to determine if there are further matches. Once a very high percentage (TBD) of phonemes match, it can be assumed that the recordings were made by the same individual.

3. Our program enables one individual to emulate the voice of another individual.
a. Our program first creates a voice signature of the person to be emulated (Emulated) utilizing the methodology outlined in number 1 above.
b. Our program then creates a voice signature of the person (Emulator) intending to emulate the Emulated's voice utilizing the methodology outlined in number 1 above.
c. Our program then creates comparison algorithms between the various phoneme combinations of the Emulator and those of the Emulated.
1. This process can be expedited by the Emulator speaking the same messages, previously spoken by the Emulated.
d. Once our program completes the comparison algorithms, the Emulator then speaks the desired message into the program, which processes the Emulator's voice. Our program then breaks down the Emulator's message to the phoneme level and applies each respective comparison algorithm. Once all the comparison algorithms are applied to all of the phonemes, the message is released over the desired medium in the voice of the Emulated.
1. If this message were to be analyzed for voice identification as outlined in number 2 above, the program would reflect the voice as belonging to the Emulated and not the Emulator.
